(19) United States
(12) Patent Application Publication
(10) Pub. No.: US 2025/0002816 A1
(43) Pub. Date: Jan. 2, 2025

(54) LIQUID CONDITIONING COMPOSITIONS COMPRISING CHITOSAN

(71) Applicant: The Procter & Gamble Company, Cincinnati, OH (US)

(72) Inventors: Olav Pieter Dora Tony KEIJZER, Brussels (BE); Laura ORLANDINI, LAUSANNE (CH); Pieter Jan Maria SAVEYN, Brussels (BE); Ariel LEBRON, Cincinnati, OH (US); Yiping SUN, Mason, OH (US); Vincenzo GUIDA, Brussels (BE); Johan SMETS, Lubbeek (BE); Rachide ELBOUSAKSAKI, Mouscron (BE)

(21) Appl. No.: 18/735,275

(22) Filed: Jun. 6, 2024

Related U.S. Application Data
(60) Provisional application No. 63/510,937, filed on Jun. 29, 2023.

(51) Int. Cl. C11D 3/00; C11D 3/22; C11D 3/30; C11D 3/50

(52) U.S. Cl. CPC C11D 3/0015; C11D 3/0084; C11D 3/222; C11D 3/30; C11D 3/505; C11D 2111/12; C11D 2111/40

(57) ABSTRACT

A liquid conditioning composition that includes from about 2% to about 8%, by weight of the composition, of an alkyl ester quaternary ammonium softening active, from 0.0001% to about 0.025%, by weight of the composition, of chitosan, and from 0.01 to about 5%, by weight of the composition, of free perfume oil, wherein the composition has a viscosity of about 80 to about 300 cPs.

### FIELD OF THE INVENTION

The present disclosure relates to liquid conditioning compositions that include chitosan. The present disclosure also relates to methods and uses of liquid conditioning compositions that include chitosan.

### BACKGROUND OF THE INVENTION

Manufacturers and consumers alike desire liquid conditioning compositions that have a desirable Neat Product Odor (NPO). When shopping, it is common for consumers to open the bottles on the supermarket shelf, to smell the product, and choose what they want to buy based on the odor of the product. Consumers also desire products with a thick consistency as high viscosity conveys a luxurious usage experience and better performance.

Unfortunately, those traits of a desirable liquid conditioning composition—good NPO and high viscosity—are not mutually exclusive, as a higher viscosity in the finished product can negatively impact the release of the free perfume and therefore decrease the NPO of the product. Accordingly, it is of continued interest to find new and useful liquid conditioning products with a desirable NPO, as well as a thick consistency.

### SUMMARY OF THE INVENTION

The present disclosure relates to liquid conditioning compositions, such as liquid fabric enhancers, that include certain amounts of chitosan.

As a nonlimiting example, the present disclosure relates to a liquid conditioning composition comprising from about 2% to about 8%, by weight of the composition, of an alkyl ester quaternary ammonium (“ester quat”) softening active; from 0.0001% to about 0.025%, by weight of the composition, of chitosan; and from 0.01 to about 5%, by weight of the composition, of free perfume oil; wherein the composition has a viscosity of about 80 to about 300 cPs.

The present disclosure also relates to methods of treating a surface, where the method includes the step of contacting a surface, preferably a fabric, more preferably a fabric comprising cotton fibers, with a liquid conditioning composition according to the present disclosure, optionally in the presence of water.

The present disclosure also relates to a concentrated softening active composition that may be used to make the liquid conditioning compositions of the present disclosure, where the concentrated softening active composition includes from about 0.0001% to about 0.025%, by weight of the composition, of chitosan, as described herein; and a liquid carrier selected from the group consisting of water, surfactant, or organic solvent.

The present disclosure also relates to the use of chitosan, preferably as part of a liquid conditioning composition, to provide Neat Product Odor (NPO) benefits, where the chitosan has a weight average molecular weight (Mw) of about 70 kDa to about 600 kDa.

### DETAILED DESCRIPTION OF THE DRAWINGS

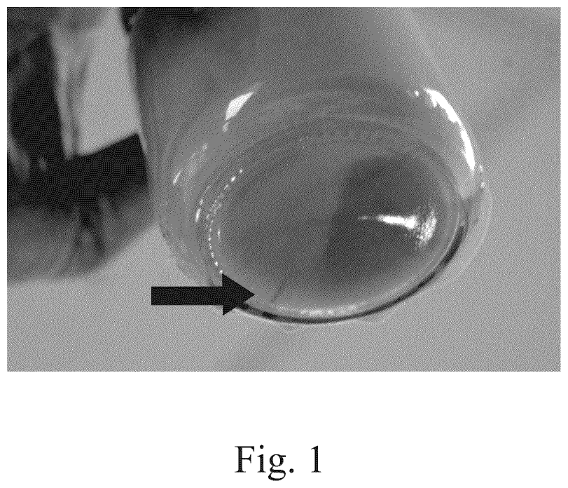

FIG. 1 is a photograph of an exemplary liquid fabric conditioner sample that exhibits a Failure Level 1 assessment score using the Method to Assess the Phase Stability of LFE Products, as detailed herein;

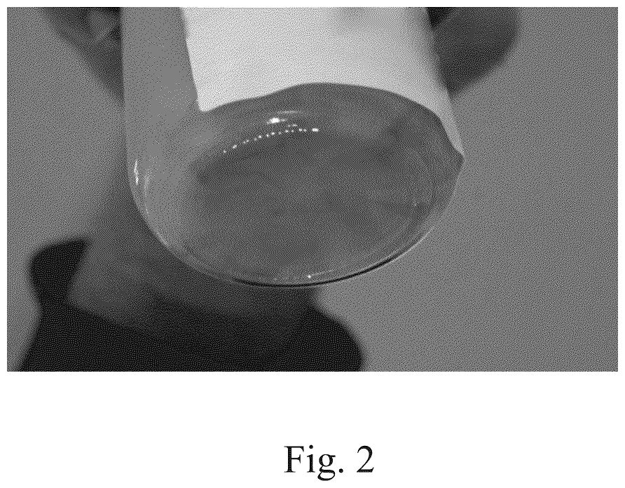

FIG. 2 is a photograph of an exemplary liquid fabric conditioner sample that exhibits a Failure Level 2 assessment score using the Method to Assess the Phase Stability of LFE Products, as detailed herein;

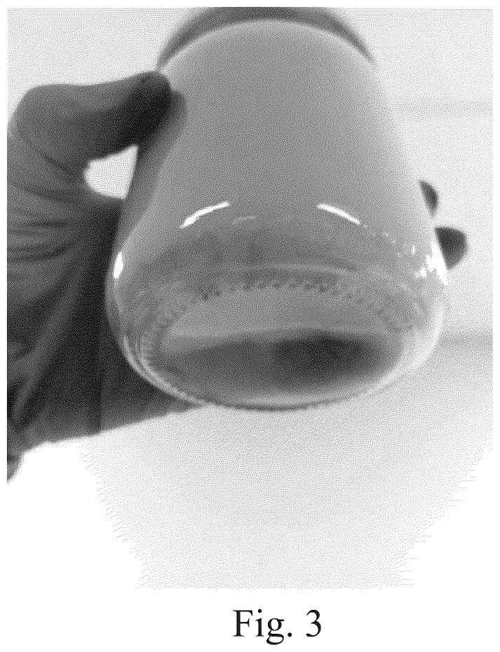

FIG. 3 is a photograph of an exemplary liquid fabric conditioner sample that exhibits a Failure Level 3 assessment score using the Method to Assess the Phase Stability of LFE Products, as detailed herein;

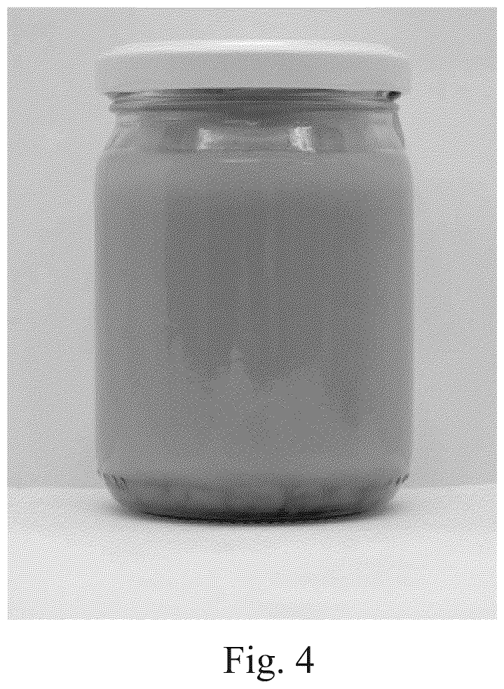

FIG. 4 is a photograph of an exemplary liquid fabric conditioner sample that exhibits a Failure Level 4 assessment score using the Method to Assess the Phase Stability of LFE Products, as detailed herein;

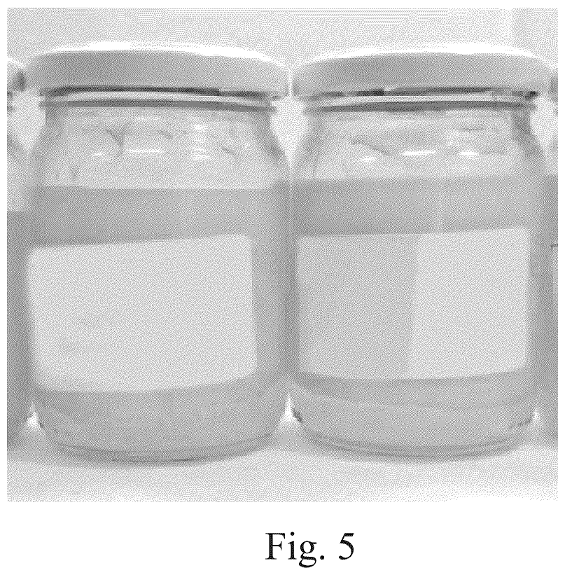

FIG. 5 is a photograph of an exemplary liquid fabric conditioner sample that exhibits a Failure Level 5 assessment score using the Method to Assess the Phase Stability of LFE Products, as detailed herein;

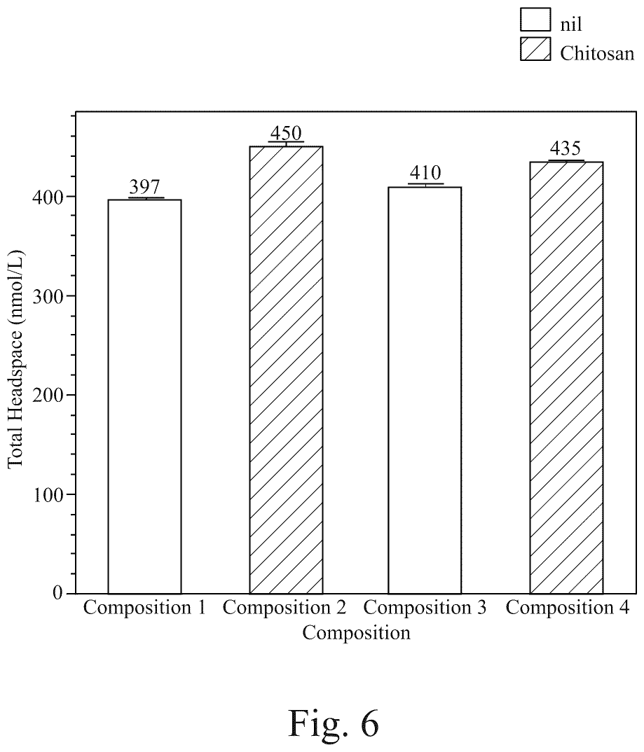

FIG. 6 is a chart detailing Neat Product Odor Headspace values for liquid fabric conditioner samples; and

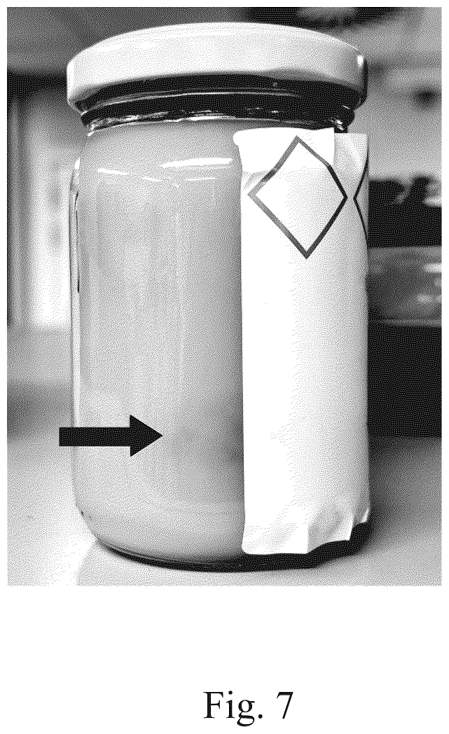

FIG. 7 is a photograph of an aged commercially available liquid fabric enhancer product with chitosan added.

### DETAILED DESCRIPTION OF THE INVENTION

The present disclosure relates to liquid conditioning compositions, such as liquid fabric enhancers, that include certain amounts of chitosan. It has been surprisingly found that the addition of chitosan to the liquid conditioning compositions enables an improved release of perfumes, and therefore an increased NPO. The materials, compositions, processes, and uses of such liquid conditioning compositions are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Liquid Conditioning Compositions

The present disclosure relates to liquid conditioning compositions. The liquid conditioning compositions may be fabric care compositions or hair care compositions, preferably liquid fabric enhancers or hair conditioners, more preferably liquid fabric enhancers.

The liquid conditioning composition may have a viscosity from about 50 cPs to about 300 cPs (about 50 mPa·s to about 300 mPa·s), or from 80 cPs to about 300 cPs, or from 90 cPs to about 250 cPs, or preferably from 150 cPs to about 250 cPs. The viscosity is determined using a Brookfield viscometer, No. 2 spindle, at 60 RPM/s, measured at about 22° C. Compositions having viscosities lower than what is provided here may be viewed as too runny and seen as “cheap”; compositions having relatively higher viscosities may result in processing or dispensing challenges.

The liquid conditioning composition may be characterized by a dynamic yield stress. For example, the dynamic yield stress at 20° C. of the fabric softener composition may be from 0.001 Pa to 1.0 Pa, preferably from 0.005 Pa to 0.8 Pa, more preferably from 0.01 Pa to 0.5 Pa. The absence of a dynamic yield stress may lead to phase instabilities such as particle creaming or settling in case the liquid composition comprises suspended particles or encapsulated benefit agents. Very high dynamic yield stresses may lead to undesired air entrapment during filling of a bottle with the fabric softener composition. Dynamic yield stress is determined according to the method provided in the Test Methods section below.

The liquid conditioning compositions of the present disclosure may be characterized by a pH of from about 2 to about 12, or from about 2 to about 8.5, or from about 2 to about 7, or from about 2 to about 5. The compositions of the present disclosure may have a pH of from about 2 to about 4, preferably a pH of from about 2 to about 3.7, more preferably a pH from about 2 to about 3.5, preferably in the form of an aqueous liquid. It is believed that acidic pH levels facilitate stability of the ester quat. The pH of a composition is determined by dissolving/dispersing the composition in deionized water to form a solution at 10% concentration, at about 20° C.

The liquid conditioning compositions of the present disclosure may comprise water. The liquid conditioning composition may comprise from about 40% to about 98%, or from about 50% to about 96%, or from about 75% to about 95%, or from about 80% to about 94%, by weight of the composition, of water. Water levels may be selected to as to balance the amount of the softening active to a desired level. The selection of the ester quats described herein is believed to be particularly useful in compositions that comprise a relatively high amount of water, as such ingredients can provide both performance and viscosity-building benefits.

The liquid conditioning compositions may be packaged in a pouring bottle. The liquid conditioning composition may be packaged in an aerosol can or other spray bottle. The packaging may be translucent or transparent.

The liquid conditioning compositions of the present disclosure may further include one or more of the following ingredients set out below.

### Chitosan

The liquid conditioning compositions of the present disclosure include a certain level of chitosan. The liquid conditioning compositions of the present disclosure may include about 0.0001% to about 0.025%, or from about 0.001% to about 0.025%, or from about 0.001% to about 0.02%, or from about 0.0015% to about 0.015%, or from about 0.002% to about 0.01%, by weight of the composition, of chitosan.

The chitosan may be partly or wholly treated with a redox initiator. The redox initiator may be selected from the group consisting of a persulfate, a peroxide, and combinations thereof. Suitable redox initiator may include ammonium persulfate, sodium persulfate, potassium persulfate, cesium persulfate, benzoyl peroxide, hydrogen peroxide, and mixtures thereof. The redox initiator may preferably be selected from sodium persulfate, hydrogen peroxide, or mixtures thereof. The redox initiator may preferably be a persulfate. The redox initiator may preferably be a peroxide. The redox initiator may preferably be sodium persulfate. Treating the chitosan with the redox initiator typically occurs in a water phase, preferably an acidic water phase, prior to forming an emulsion that results in formation of the delivery particles. In the reaction that forms the modified chitosan, the redox initiator and the chitosan may be present in a weight ratio of from about 90:10 to about 0.01:99.99, preferably from about 50:50 to about 1:99, more preferably from about 30:70 to about 3:97.

The chitosan may be partly or wholly acid-treated chitosan. For example, chitosan (which, prior to acid treatment, may be referred to as raw chitosan or parent chitosan) may be treated at a pH of 6.5 or less with an acid for at least one hour, preferably from about one hour to about three hours, or for a period of time required to obtain a chitosan solution viscosity of not more than about 1500 cps, or even not more than 500 cps, at a temperature of from about 25° C. to about 99° C., preferably from about 75° C. to about 95° C. The acid may be selected from a strong acid (such as hydrochloric acid), an organic acid (such as formic acid or acetic acid), or a mixture thereof. The chitosan may preferably be acid-treated at a pH of from 2 to 6.5, preferably a pH of from about 3 to about 6, or even from a pH of from 4 to 6.

The chitosan, more preferably acid-treated chitosan, may preferably be characterized by a molecular weight of from about 70 kDa to about 600 kDa, preferably from about 90 kDa to about 400 kDa, even more preferably from about 100 kDa to about 300 kDa, even more preferably from about 100 kDa to about 250 kDa. Without wishing to be bound by theory, it is believed that biopolymers characterized by a relatively low molecular weight are less effective at forming suitable delivery particles, while those having relatively high molecular weights tend to be difficult to process. The method used to determine the chitosan's molecular weight and related parameters is provided in the Test Methods section below and uses gel permeation chromatograph with multi-angle light scatter and refractive index detection (GPC-MALS/RI) techniques.

The chitosan may be characterized by a degree of deacetylation of at least 50%, preferably from about 50% to about 99%, more preferably from about 75% to about 90%, even more preferably from about 80% to about 85%. The degree of deacetylation can affect the solubility of the chitosan, which in turn can affect its reactivity or behavior in the process of forming the particle shells. For example, a degree of deacetylation that is too low (e.g., below 50%) results in chitosan that is relatively insoluble and relatively unreactive. A degree of deacetylation that is relatively high can result in chitosan that is very soluble, resulting in relatively little of it traveling to the oil/water interface during shell formation.

The chitosan, when present, may comprise anionically modified chitosan, cationically modified chitosan, or a combination thereof. Modifying the chitosan in an anionic and/or cationic fashion can change the character of the shell of the delivery particle, for example, by changing the surface charge and/or zeta potential, which can affect the deposition efficiency and/or formulation compatibility of the particles.

### Ester Quat

The liquid conditioning compositions of the present disclosure comprise certain alkyl quaternary ammonium ester materials, also called “ester quats” herein. Such ester quats may be useful for providing conditioning benefits such as softness, anti-wrinkle, anti-static, conditioning, anti-stretch, color, and/or appearance benefits to target fabrics. Additionally, the ester quats of the present disclosure are useful in building viscosity at relatively low active levels.

The liquid conditioning composition may comprise from about 2% to about 20%, or from about 2% to about 15%, or from about 2% to about 12%, by weight of the composition, of the ester quat softening active, described in more detail below. The composition may comprise from about 2% to about 10%, preferably from about 2% to about 8%, more preferably from about 3% to about 7%, even more preferably from about 3% to about 6% by weight of the composition, of the ester quat softening active. The composition may comprise from about 2% to about 8%, by weight of the composition, of the ester quat softening active.

Suitable quaternary ammonium ester softening actives include, but are not limited to, materials selected from the group consisting of monoester quats, diester quats, triester quats and mixtures thereof. Preferably, the level of monoester quat is from 2.0% to 40.0%, the level of diester quat is from 40.0% to 98.0%, the level of triester quat is from 0.0% to 25.0% by weight of total quaternary ammonium ester softening active.

Said quaternary ammonium ester softening active may comprise compounds of the following formula:

{R2(4-m)-N+-[X—Y—R1]m}A-

wherein:
m is 1, 2 or 3 with proviso that the value of each m is identical;
each R1 is independently hydrocarbyl, or branched hydrocarbyl group, preferably R1 is linear, more preferably R1 is partially unsaturated linear alkyl chain;
each R2 is independently a C1-C3 alkyl or hydroxyalkyl group, preferably R2 is selected from methyl, ethyl, propyl, hydroxyethyl, 2-hydroxypropyl, 1-methyl-2 hydroxyethyl, poly(C2-3-alkoxy), polyethoxy, benzyl;
each X is independently —(CH2)n-, —CH2-CH(CH3)- or —CH(CH3)-CH2- and
each n is independently 1, 2, 3 or 4, preferably each n is 2;
each Y is independently —O—(O)C— or —C(O)—O—;
A- is independently selected from the group consisting of chloride, methyl sulfate, and ethyl sulfate, preferably A- is selected from the group consisting of chloride and methyl sulfate;
with the proviso that when Y is —O—(O)C—, the sum of carbons in each R1 is from 13 to 21, preferably from 13 to 19. Preferably, X is —CH2-CH(CH3)- or —CH(CH3)-CH2- to further improve the hydrolytic stability of the quaternary ammonium ester softening active, and hence further improve the stability of the liquid fabric softener composition.

Because of the balance of processability and odor of the quaternary ammonium ester softening active, in preferred liquid fabric softener compositions, the iodine value of the parent fatty acid from which the quaternary ammonium fabric softening active is formed is from 0 to 100, more preferably from 10 to 60, even more preferably from 15 to 45.

The ester quat softening actives are derived from a fatty acid feedstock. The fatty acid feedstock comprises fatty acids. The fatty acid feedstock may be partially hydrogenated, as such processes can provide the desired amount of trans fatty acids. By “partially hydrogenated” as used herein, it is meant that either the fatty acids themselves undergo a partial hydrogenation process, or that the oil from which the fatty acids are derived undergoes a hydrogenation process, or both. Additionally, partial hydrogenation processes can reduce the amount of double-unsaturated fatty acids, the presence of which may lead to color and/or odor instabilities in final product.

The fatty acids may be derived from plants. Suitable sources of plant-derived fatty acids may include vegetable oils, such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, and the like. Preferably, the fatty acid feedstock comprises fatty acids that are derived from cottonseed, rapeseed, sunflower seed, or soybean, preferably from cottonseed. These materials are particularly preferred because they tend to produce fatty acids having a desirable trans-unsaturation content upon partial hydrogenation. Thus, the fatty acid feedstock may comprise partially hydrogenated fatty acids derived from plants, preferably derived from vegetable oils, more preferably derived from canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, or mixtures thereof, more preferably derived from cottonseed, rapeseed, sunflower seed, soybean, or mixtures thereof. The fatty acid may comprise, at least in part, partially hydrogenated fatty acids derived from cotton seed oil, as such materials are believed to have advantageous distributions of fatty acid types and trans-unsaturated bonds.

The fatty acids may include an alkyl portion containing, on average by weight, from about 13 to about 22 carbon atoms, or from about 14 to about 20 carbon atoms, preferably from about 16 to about 18 carbon atoms, where the carbon count includes the carbon of the carboxyl group. The population of fatty acids may be present in a distribution of alkyl chains sizes. A particular fatty acid may be characterized by the number of carbons in its alkyl portion. For example, a fatty acid having sixteen carbons in the alkyl portion may be called a “C16 fatty acid.” Likewise, a fatty acid having eighteen carbons in the alkyl portion may be called a “C18 fatty acid.”

The fatty acid feedstock may comprise less than 25%, by weight of the fatty acid feedstock, of C16 fatty acids. The fatty acid feedstock may comprise from about 5% to about 25%, preferably from about 10% to about 25%, more preferably from about 15% to about 25%, even more preferably from about 20% to about 25%, by weight of the fatty acid feedstock, of C16 fatty acids. It may be desirable to limit the relative amount of C16 fatty acids in the fatty acid feedstock. Without wishing to be bound by theory, it is believed that it a relatively high proportion of C16 fatty acids (especially relative to C18 fatty acids) may lead to relatively lower viscosities in the final product.

Additionally, or alternatively, it may be desirable to have at least a certain minimum of C16 fatty acids in the fatty acid feedstock (e.g., at least 10%, preferably at least 15%, even more preferably at least 20%, by weight of the fatty acid feedstock). Such materials can help to improve processability, as esterquats based on materials that include C16 fatty acids tend to have lower melting points and may be relatively easier to disperse compared to esterquats produced primarily from the more crystalline C18 (and/or C18-trans) fatty acids with low/nil levels of C16s.

The alkyl quaternary ammonium ester softening actives may comprise compounds formed from fatty acids that are unsaturated, meaning that the fatty acids comprise at least one double bond in the alkyl portion. The fatty acids may be monounsaturated (one double bond), or they may be di-unsaturated (or double-unsaturated; two double bonds). Preferably, most of the unsaturated fatty acids in the fatty acid feedstock are monounsaturated.

The fatty acids may comprise unsaturated C18 chains, which may include a single double bond (“C18:1”) or may be double unsaturated (“C18:2”). (For reference, a fatty acid with a saturated C18 chain may be referred to as “C18:0”.) The fatty acid feedstock may comprise from about 50% to about 85%, preferably from about 60% to about 80%, more preferably from about 70% to about 80%, by weight of the fatty acid feedstock, of C18 fatty acids, regardless of saturated or unsaturated status. The fatty acid feedstock may comprise from about 20% to about 60%, preferably from about 40% to about 60%, more preferably from about 45% to about 55%, by weight of the fatty acid feedstock, of C18:0 fatty acids. The fatty acid feedstock may comprise from about 15% to about 50%, preferably from about 15% to about 30%, preferably from about 18% to about 25%, by weight of the fatty acid feedstock, of C18:1 fatty acids. The fatty acid feedstock may comprise from 0% (e.g., none) to about 20%, or from about 0% to about 15%, or from about 0% to about 10%, or from about 0% to about 5%, by weight of the fatty acid feedstock, of C18:2 fatty acids. The fatty acid feedstock may comprise from about 1% to about 15%, preferably from about 5% to about 10%, by weight of the fatty acid feedstock, of C18:2 fatty acids.

The ester quat material may be produced in a two-step synthesis process. First, an esteramine may be produced by running an esterification reaction using fatty acids and an alkanolamine. In a second step, the product may be quaternized using an alkylating agent.

The liquid conditioning compositions of the present disclosure may comprise other conditioning agents in addition to the ester quats described above. The other conditioning agents may be selected from the group consisting of quaternary ammonium ester compounds other than those described above, silicones, non-ester quaternary ammonium compounds, amines, fatty esters, sucrose esters, silicones, dispersible polyolefins, polysaccharides, fatty acids, softening or conditioning oils, polymer latexes, glyceride copolymers, or combinations thereof.

Examples of suitable quaternary ammonium ester softening actives are commercially available from KAO Chemicals under the trade name Tetranyl® AT-1 and Tetranyl® AT-7590, from Evonik under the tradename Rewoquat® WE16 DPG, Rewoquat® WE18, Rewoquat® WE20, Rewoquat® WE28, and Rewoquat® 38 DPG, from Stepan under the tradename Stepantex® GA90, Stepantex® VR90, Stepantex® VK90, Stepantex® VA90, Stepantex® DC90, and Stepantex® VL90A.

These types of agents and general methods of making them are disclosed in U.S. Pat. No. 4,137,180.

### Perfume and Perfume Delivery Systems

The liquid conditioning compositions may comprise perfume, a perfume delivery system, or a combination thereof. Such systems may improve the freshness performance of the compositions described herein. In particular, perfume delivery systems may facilitate improved freshness performance by increasing deposition efficiency, facilitating perfume release at different touchpoints, and/or increasing longevity of perfume performance.

### Neat Perfume

Perfume may be present as neat oil, sometimes referred to as, for example, “free” perfume, unencapsulated perfume, or free perfume oil. The liquid conditioning compositions may comprise from about 0.01% to about 5%, or from about 0.05% to about 4%, or from about 0.1% to about 3%, or from about 0.5% to about 2%, by weight of the composition, or free perfume oil.

Neat oil can comprise perfume raw materials such as 3-(4-1-butylphenyl)-2-methyl propanal, 3-(4-1-butylphenyl)-propanal, 3-(4-isopropylphenyl)-2-methylpropanal, 3-(3,4-methylenedioxyphenyl)-2-methylpropanal, and 2,6-dimethyl-5-heptenal, alpha-damascone, beta-damascone, gamma-damascone, beta-damascenone, 6,7-dihydro-1,1,2,3,3-pentamethyl-4 (5H)-indanone, methyl-7,3-dihydro-2H-1,5-benzodioxepine-3-one, 2-[2-(4-methyl-3-cyclohexenyl-1-yl) propyl]cyclopentan-2-one, 2-sec-butylcyclohexanone, and beta-dihydro ionone, linalool, ethyllinalool, tetrahydrolinalool, and dihydromyrcenol; silicone oils, waxes such as polyethylene waxes; essential oils such as fish oils, jasmine, camphor, lavender; skin coolants such as menthol, methyl lactate; vitamins such as Vitamin A and E; sunscreens; glycerine; catalysts such as manganese catalysts or bleach catalysts; bleach particles such as perborates; silicon dioxide particles; antiperspirant actives; cationic polymers and mixtures thereof. Suitable benefit agents can be obtained from Givaudan Corp. of Mount Olive, New Jersey, USA, International Flavors & Fragrances Corp. of South Brunswick, New Jersey, USA, or Firmenich Company of Geneva, Switzerland or Encapsys Company of Appleton, Wisconsin (USA). As used herein, a “perfume raw material” refers to one or more of the following ingredients: fragrant essential oils; aroma compounds; pro-perfumes; materials supplied with the fragrant essential oils, aroma compounds, and/or pro-perfumes, including stabilizers, diluents, processing agents, and contaminants; and any material that commonly accompanies fragrant essential oils, aroma compounds, and/or pro-perfumes.

### Perfume Delivery Systems

The perfume delivery system may comprise encapsulates, for example, where a core is surrounded by wall material (“core-shell encapsulates”); the core may comprise perfume and optionally a partitioning modifier (e.g., isopropyl myristate). The wall material may include melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, or mixtures thereof. The melamine wall material may comprise melamine crosslinked with formaldehyde, melamine-dimethoxyethanol crosslinked with formaldehyde, and mixtures thereof; encapsulates with such wall materials may be used in combination with a formaldehyde scavenger, such as acetoacetamide, urea, or derivatives thereof. The polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The polyacrylate ester-based wall materials may comprise polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof.

The aromatic alcohol-based wall material may comprise aryloxyalkanols, arylalkanols and oligoalkanolarylethers. It may also comprise aromatic compounds with at least one free hydroxyl-group, especially preferred at least two free hydroxy groups that are directly aromatically coupled, wherein it is especially preferred if at least two free hydroxy-groups are coupled directly to an aromatic ring, and more especially preferred, positioned relative to each other in meta position. It is preferred that the aromatic alcohols are selected from phenols, cresoles (o-, m-, and p-cresol), naphthols (alpha and beta-naphthol) and thymol, as well as ethylphenols, propylphenols, fluorophenols and methoxyphenols.

The polyurea based wall material may comprise a polyisocyanate. The shell of the delivery particles may comprise a polymeric material that may be the reaction product of a polyisocyanate and a chitosan. The shell may comprise a polyurea resin, where the polyurea resin comprises the reaction product of a polyisocyanate and chitosan. The delivery particles of the present disclosure may be considered polyurea delivery particles and include a polyurea-chitosan shell. (As used herein, “shell” and “wall” are used interchangeably with regard to the delivery particles, unless indicated otherwise.) The shell may be derived from isocyanates and chitosan.

The delivery particles may be made according to a process that comprises the following steps: forming a water phase comprising chitosan in an aqueous acidic medium; forming an oil phase comprising dissolving together at least one benefit agent and at least one polyisocyanate; forming an emulsion by mixing under high shear agitation the water phase and the oil phase into an excess of the water phase, thereby forming droplets of the oil phase and benefit agent dispersed in the water phase; curing the emulsion by heating, for a time sufficient to form a shell at an interface of the droplets with the water phase, the shell comprising the reaction product of the polyisocyanate and chitosan, and the shell surrounding the core comprising the droplets of the oil phase and benefit agent. Diluents, for example isopropyl myristate, may be used to adjust the hydrophilicity of the oil phase. The oil phase is then added into the water phase and milled at high speed to obtain a targeted size. The emulsion is then cured in one or more heating steps.

The temperature and time are selected to be sufficient to form and cure a shell at the interface of the droplets of the oil phase with the water continuous phase. For example, the emulsion is heated to 85° C. in 60 minutes and then held at 85° C. for 360 minutes to cure the particles. The slurry is then cooled to room temperature.

Chitosan (as defined herein in the Chitosan section) as a percentage by weight of the shell may be from about 21% up to about 95% of the shell. The ratio of the isocyanate monomer, oligomer, or prepolymer to chitosan may be up to 1:10 by weight.

The polyisocyanate may be an aliphatic or aromatic monomer, oligomer or prepolymer, usefully comprising two or more isocyanate functional groups. The polyisocyanate may preferably be selected from a group comprising toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, and phenylene diisocyanate.

The polyisocyanate, for example, can be selected from aromatic toluene diisocyanate and its derivatives used in wall formation for encapsulates, or aliphatic monomer, oligomer or prepolymer, for example, hexamethylene diisocyanate and dimers or trimers thereof, or 3,3,5-trimethyl-5-isocyanatomethyl-1-isocyanato cyclohexane tetramethylene diisocyanate. The polyisocyanate can be selected from 1,3-diisocyanato-2-methylbenzene, hydrogenated MDI, bis(4-isocyanatocyclohexyl) methane, dicyclohexylmethane-4,4′-diisocyanate, and oligomers and prepolymers thereof. This listing is illustrative and not intended to be limiting of the polyisocyanates useful in the present disclosure.

The polyisocyanates useful in the invention comprise isocyanate monomers, oligomers or prepolymers, or dimers or trimers thereof, having at least two isocyanate groups. Optimal crosslinking can be achieved with polyisocyanates having at least three functional groups. Polyisocyanates, for purposes of the present disclosure, are understood as encompassing any polyisocyanate having at least two isocyanate groups and comprising an aliphatic or aromatic moiety in the monomer, oligomer, or prepolymer. If aromatic, the aromatic moiety can comprise a phenyl, a toluyl, a xylyl, a naphthyl or a diphenyl moiety, more preferably a toluyl or a xylyl moiety. Aromatic polyisocyanates, for purposes herein, can include diisocyanate derivatives such as biurets and polyisocyanurates. The polyisocyanate, when aromatic, can be, but is not limited to, methylene diphenyl isocyanate, toluene diisocyanate, tetramethylxylidene diisocyanate, polyisocyanurate of toluene diisocyanate (commercially available from Bayer under the tradename Desmodur® RC), trimethylol propane-adduct of toluene diisocyanate (commercially available from Bayer under the tradename Desmodur® L75), or trimethylol propane-adduct of xylylene diisocyanate (commercially available from Mitsui Chemicals under the tradename Takenate® D-110N), naphthalene-1,5-diisocyanate, and phenylene 5 diisocyanatc.

There is a preference for aromatic polyisocyanate; however, aliphatic polyisocyanates and blends thereof may be useful. Aliphatic polyisocyanate is understood as a polyisocyanate which does not comprise any aromatic moiety. Aliphatic polyisocyanates include a trimer of hexamethylene diisocyanate, a trimer of isophorone diisocyanate, a trimethylol propane-adduct of hexamethylene diisocyanate (available from Mitsui Chemicals) or a biuret of hexamethylene diisocyanate (commercially available from Bayer under the tradename Desmodur® N 100). The shell may degrade at least 50% after 20 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

The composition may comprise from about 0.05% to about 20%, or from about 0.05% to about 10%, or from about 0.1% to about 5%, or from about 0.2% to about 2%, by weight of the composition, of delivery particles. The composition may comprise a sufficient amount of delivery particles to provide from about 0.05% to about 10%, or from about 0.1% to about 5%, or from about 0.1% to about 2%, by weight of the composition, of the encapsulated benefit agent, which may preferably be perfume raw materials, to the composition. When discussing herein the amount or weight percentage of the delivery particles, it is meant the sum of the wall material and the core material.

The delivery particles according to the present disclosure may be characterized by a volume-weighted median particle size from about 1 to about 100 microns, preferably from about 10 to about 100 microns, preferably from about 15 to about 50 microns, more preferably from about 20 to about 40 microns, even more preferably from about 20 to about 30 microns. Different particle sizes are obtainable by controlling droplet size during emulsification.

The delivery particles may be characterized by a ratio of core to shell up to 85:15, up to 90:10, up to 99:1, or even 99.5:0.5 on the basis of weight.

The encapsulates may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethylencimine, polyvinylalcohol, polyacrylates, a polysaccharide (e.g., chitosan), and combinations thereof.

The perfume delivery system may comprise particles that comprise a graft copolymer and a fragrance material, where the graft copolymer comprises a polyalkylene glycol (e.g., polyethylene glycol) as a graft base and one or more side chains that comprise vinyl acetate moieties.

The perfume delivery system may comprise a pro-perfume, for example a siloxane-based pro-perfume, where a perfume raw material is associated with (for example, via covalent bonding) a polymer (e.g., a siloxane polymer) upon delivery to a surface and is released upon or after treatment of a surface with the composition.

The perfume delivery system may comprise self-assembling particles composed of rosin materials, such as gum rosin, wood rosin, tall oil rosin, or their derivatives, preferably their ester derivatives, even more preferably their glycerol ester derivatives. Particles may be obtained by a self-assembling process. The self-assembling process involves adding the plant rosin material, either with or after the perfume, to the product composition. Optionally, an emulsifying agent can be included to aid in particle formation within the final product. The preferred perfume raw materials to be encapsulated within these self-assembling particles are those that contain a moiety selected from a cycloalkane, a cycloalkene, a branched alkane, or a combination thereof. The particle size can range from 10 um to 90 um.

When the perfume delivery system includes formaldehyde derivatives, such as perfume encapsulates with melamine-formaldehyde shells, the composition may further comprise a formaldehyde scavenger, which may comprise a sulfur-based formaldehyde scavenger, a non-sulfur-based formaldehyde scavenger, or mixtures thereof. Suitable non-sulfur-based formaldehyde scavengers may include urea, ethylene urea, acetoacetamide, or mixtures thereof. Suitable sulfur-based formaldehyde scavengers may include alkali and/or alkali earth metal dithionites, pyrosulfites, sulfites, bisulfites, metasulfites, monoalkyl sulphites, dialkyl sulphites, dialkylene sulphites, sulfides, thiosulfates, thiocyanates, mercaptans, thiourea, and mixtures thereof.

### Treatment Adjuncts

The liquid conditioning compositions of the present disclosure may include other treatment adjunct ingredients. The adjunct ingredients may be selected to provide, for example, processing, stability, and/or performance benefits.

Suitable treatment adjuncts may include surfactants, conditioning actives, deposition aids, rheology modifiers or structurants, bleach systems, stabilizers, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure elasticizing agents, carriers, hydrotropes, processing aids, structurants, anti-agglomeration agents, coatings, formaldehyde scavengers, and/or pigments.

In particular, the liquid conditioning composition may further comprise a treatment adjunct selected from the group consisting of: additional conditioning agents, dyes, pH control agents, solvents, rheology modifiers, structurants, cationic polymers, surfactants, perfume, perfume delivery systems, chelants, antioxidants, preservatives, or mixtures thereof.

The precise nature of these additional components, and levels of incorporation thereof, will depend on the physical form of the composition and the nature of the operation for which the resulting composition is to be used. However, when one or more adjuncts are present, such one or more adjuncts may be present as detailed below. The following is a non-limiting list of adjunct ingredients that may be useful.

### 1. Rheology Modifier/Structurant

The liquid conditioning compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles in liquid composition, such as perfume encapsulates as described herein.

Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof.

Polymeric structuring agents may be naturally derived or synthetic in origin. Naturally derived polymeric structurants may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof. Synthetic polymeric structurants may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C1-C30 alkyl ester of the (meth)acrylic acid. Such copolymers are available from Noveon Inc. under the tradename Carbopol Aqua 30. Another suitable structurant is sold under the tradename Flosoft FS 222 available from SNF Floerger.

### 2. Cationic Polymer

The liquid conditioning compositions of the present disclosure may comprise a cationic polymer. Cationic polymers may serve as deposition aids, e.g., facilitating improved deposition efficiency of softening and/or freshness actives onto a target surface. Additionally or alternatively, cationic polymers may provide stability, structuring, and/or rheology benefits to the composition.

The liquid conditioning compositions may comprise, by weight of the composition, from 0.0001% to 3%, preferably from 0.0005% to 2%, more preferably from 0.001% to 1%, or from about 0.01% to about 0.5%, or from about 0.05% to about 0.3%, of a cationic polymer.

Cationic polymers in general and their methods of manufacture are known in the literature. Suitable cationic polymers may include quaternary ammonium polymers known the “Polyquaternium” polymers, as designated by the International Nomenclature for Cosmetic Ingredients, such as Polyquaternium-6 (poly(diallyldimethylammonium chloride), Polyquaternium-7 (copolymer of acrylamide and diallyldimethylammonium chloride), Polyquaternium-10 (quaternized hydroxyethyl cellulose), Polyquaternium-22 (copolymer of acrylic acid and diallyldimethylammonium chloride), and the like.

The cationic polymer may comprise a cationic polysaccharide, such as cationic starch, cationic cellulose, cationic guar, or mixtures thereof. The cationic cellulose may comprise a quaternized hydroxyethyl cellulose. Polymers derived from polysaccharides may be preferred, being naturally derived and/or sustainable materials.

The cationic polymer may comprise a cationic acrylate. The cationic polymer may comprise cationic monomers, nonionic monomers, and optionally anionic monomers (so long as the overall charge of the polymer is still cationic. The cationic polymer may comprise cationic monomers selected from the group consisting of methyl chloride quaternized dimethyl aminoethylammonium acrylate, methyl chloride quaternized dimethyl aminoethylammonium methacrylate and mixtures thereof. The cationic polymer may comprise nonionic monomers selected from the group consisting of acrylamide, dimethyl acrylamide and mixtures thereof. The cationic polymer may optionally comprise anionic monomers selected from acrylic acid, methacrylic acid, itaconic acid, crotonic acid, maleic acid, fumaric acid, as well as monomers performing a sulfonic acid or phosphonic acid functions, such as 2-acrylamido-2-methyl propane sulfonic acid (ATBS), and their salts.

The cationic polymer may substantially linear or may be cross-linked. The composition may comprise both a substantially linear cationic polymer (e.g., formed with less than 50 ppm cross-linking agent) and a cross-linked cationic polymer (e.g., formed with greater than 50 ppm cross-linking agent). Such combinations may provide both deposition and structuring benefits.

### 3. Surfactant

The liquid conditioning compositions may include less than 5%, or less than 2%, or less than 1%, or less than about 0.1%, by weight of the composition, of anionic surfactant, or even be substantially free of anionic surfactant. Anionic surfactants can negatively impact the stability and/or performance of the present compositions, as they may undesirably interact with cationic components such as the conditioning compounds. Product compositions intended to be added during the rinse cycle of an automatic washing machine, such as a liquid fabric enhancer, may include relatively low levels of anionic surfactant. Additionally or alternatively, compositions intended to be used in combination with a detergent composition during the wash cycle of an automatic washing machine may include relatively low levels of anionic surfactant.

The liquid conditioning compositions may comprise nonionic surfactant. Such surfactants may provide, for example, stability and/or processing benefits. The nonionic surfactants may be emulsifiers, for example, of perfume. The nonionic surfactants may be alkoxylated fatty alcohols, such as ethoxylated C10-C18 fatty alcohols.

### 4. Chelant

The liquid conditioning compositions may comprise a chelant (aka, chelating agent). Such agents may be iron and/or manganese and/or other metal ion chelating agents. Such chelating agents can be selected from the group consisting of amino carboxylates, amino phosphonates, polyfunctionally-substituted aromatic chelating agents, and mixtures therein. If utilized, these chelating agents will generally comprise from about 0.1% to about 15%, preferably from about 0.1% to about 3.0%, by weight of the compositions described herein. More preferably, if utilized, the chelating agents will comprise from about 0.1% to about 3.0% by weight of such compositions.

Suitable chelants may include: diethylenetriaminepentaacetic acid (DTPA); hydroxyethanedimethylenephosphonic acid (HEDP); MGDA (methylglycinediacetic acid); glutamic acid, N,N-diacetic acid (GLDA); 1,2-diydroxybenzene-3,5-disulfonic acid (Tiron™); ethylenediamine disuccinate (EDDS); diethylenetriamine penta(methylene phosphonic acid) (DTPMP); ethylenediaminetetrakis(methylenephosphonates); ethylenediaminetetracetates; N-(hydroxyethyl) ethylenediaminetriacetates; nitrilotriacetates; ethylenediamine tetraproprionates; triethylenetetraaminehexacetates; diethylenetriamine-pentaacetates; ethanoldiglycines; alkali metal, ammonium, or substituted ammonium salts thereof; dihydroxydisulfobenzenes such as 1,2-dihydroxy-3,5-disulfobenzene; and mixtures thereof.

### 5. Antioxidants

The liquid conditioning compositions may comprise an antioxidant, preferably a phenolic antioxidant, more preferably a tocopherol antioxidant or a derivative thereof. Antioxidants in the presently disclosed composition may be useful for malodor control, cleaning performance, and/or color stability, as they may help to reduce yellowing that may be associated with amines. Furthermore, and without wishing to be bound by theory, it is believed that the presence of an antioxidant will reduce the rate of auto-oxidation of the trans-unsaturated bonds of the ester quat fatty acid chains and may therefore contribute to viscosity stability of the compositions. Antioxidants are substances as described in Kirk-Othmer (Vol. 3, page 424) and in Ullmann's Encyclopedia (Vol. 3, page 91).

The compositions of the present disclosure may include an antioxidant, preferably a phenolic antioxidant, even more preferably a tocopherol or a derivative thereof, in an amount of from about 0.001% to about 2%, preferably from about 0.01% to about 0.5%, by weight of the composition.

A specifically preferred class of antioxidants for use in the compositions of the present disclosure are tocopherols and derivatives thereof, such as tocotrienols. Such antioxidants are typically naturally derived and therefore may be of particular interest to be coupled with an ester quat material for sustainability/environmental reasons. Furthermore, such compounds may be viewed by the consumer as familiar, beneficial, and safe due to the vitamin E activity of the compounds. Tocopherols useful in the present compositions may include alpha-tocopherol, beta-tocopherol, gamma-tocopherol, delta-tocopherol, or combinations thereof.

Other suitable antioxidants may include other phenolic antioxidants, such as butylated hydroxytoluene (“BHT”; specifically, 3,5-di-tert-butyl-4-hydroxytoluene) and butylated hydroxyanisol (“BHA”). Still other suitable antioxidants may include Proxel GXL™, Trolox™, Raluquin™, and/or those sold under the TINOGARD® tradename.

### 6. Preservative

The liquid conditioning composition may comprise a preservative, which can help with product stability upon storage. The preservative may comprise a diphenyl ether antimicrobial agent, preferably 4-4′-dichloro-2-hydroxydiphenyl ether, 2,4,4′-trichloro-2′-hydroxydiphenyl ether, or combinations thereof. The preservative may comprise a quaternary ammonium antimicrobial agent, preferably dialkyl quaternary ammonium antimicrobial agents. Suitable preservative may include those sold under the TINOSAN and/or BARQUAT tradenames.

### 7. Additional Conditioning Agents

The liquid conditioning compositions of the present disclosure may comprise other conditioning agents in addition to the ester quats described above. The additional conditioning agents may be selected from the group consisting of quaternary ammonium ester compounds other than those described above, silicones, non-ester quaternary ammonium compounds, amines, fatty esters, sucrose esters, silicones, dispersible polyolefins, polysaccharides, fatty acids, softening or conditioning oils, polymer latexes, glyceride copolymers, or combinations thereof.

The composition may include a combination of a quaternary ammonium ester compound and a silicone. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1. When determining amounts of quaternary ammonium ester compounds as described in this paragraph, the amount may refer to ester quats as described in the previous section, or the total amount of ester quats as described above, plus any additional quaternary ammonium ester compounds that may be present.

### Concentrated Feedstock Composition

The present disclosure also relates to concentrated feedstock compositions that comprise the chitosan material described above, particularly a chitosan material with a weight average molecular weight (Mw) of 70-600 kDa, and a degree of deacetylation higher than 50%. For example, the chitosan material may be made and formulated into a concentrated feedstock composition, which may then be stored and/or transported, eventually being combined with an adjunct ingredient at another time or place to form a liquid conditioning composition according to the present disclosure.

The concentrated softening active composition may further comprise a liquid carrier. The liquid carrier may be selected from the group consisting of water, surfactant, or organic solvent. Suitable surfactants may include nonionic surfactants, such as alkoxylated fatty alcohols. Suitable organic solvents may include propanediol, ethanol, isopropanol, or propylene glycol.

### Method of Making

The present disclosure relates to processes for making a liquid conditioning composition as described herein. The process of making a composition, which may be a fabric enhancer composition, may comprise the step of mixing an amount of chitosan as described herein with an ester quat, perfume and one or more treatment adjuncts.

The liquid conditioning composition of the present disclosure can be formulated into any suitable liquid form and prepared by any process chosen by the formulator. The materials may be combined in a batch process, in a circulation loop process, and/or by an in-line mixing process. Suitable equipment for use in the processes disclosed herein may include continuous stirred tank reactors, homogenizers, turbine agitators, recirculating pumps, paddle mixers, high shear mixers, static mixers, plough shear mixers, ribbon blenders, vertical axis granulators and drum mixers, both in batch and, where available, in continuous process configurations, spray dryers, and extruders.

The liquid conditioning composition may be placed into a pourable bottle by known methods. The liquid conditioning composition may be placed into an aerosol or other spray container according to known methods.

### Method of Treatment

The present disclosure further relates to methods of treating a surface, such as a fabric or hair, with a liquid conditioning composition. Such methods may provide conditioning and/or freshening benefits.

The method may include a step of contacting a surface, preferably a fabric, more preferably a fabric comprising cotton fibers, with a liquid conditioning composition of the present disclosure, optionally in the presence of water. The composition may be in neat form or diluted in a liquor, for example, a wash or rinse liquor. The composition may be diluted in water prior, during, or after contacting the surface or article. The surface, e.g., the fabric, may be optionally washed and/or rinsed before and/or after the contacting step. The composition may be applied directly onto a fabric or provided to a dispensing vessel or drum of an automatic laundry machine. The method may include drying the surface, for example passively and/or via an active method such as a laundry dryer. The method may occur during the wash cycle or the rinse cycle, preferably the rinse cycle, of an automatic washing machine.

For purposes of the present disclosure, treatment may include but is not limited to scrubbing and/or mechanical agitation. The fabric may comprise most any fabric capable of being laundered or treated in normal consumer use conditions.

Liquors that comprise the disclosed compositions may have a pH of from about 3 to about 11.5. When diluted, such compositions are typically employed at concentrations of from about 500 ppm to about 15,000 ppm in solution. When the wash solvent is water, the water temperature typically ranges from about 5° C. to about 90° C. and, the water to fabric ratio may be typically from about 1:1 to about 30:1.

### Use

The present disclosure also relates to the use of a chitosan material as described herein, preferably as part of a liquid conditioning composition, to improve Neat Product Odor of the liquid conditioning composition. It is believed that such uses are likely to be particularly attractive to consumer who desire good smelling products.

### Combinations

Specifically contemplated combinations of the disclosure are herein described in the following lettered paragraphs. These combinations are intended to be illustrative in nature and are not intended to be limiting.

A. A liquid conditioning composition that includes from about 2% to about 8%, by weight of the composition, of an alkyl ester quaternary ammonium softening active, from 0.0001% to about 0.025%, by weight of the composition, of chitosan, and from 0.01 to about 5%, by weight of the composition, of free perfume oil, wherein the composition has a viscosity of about 80 to about 300 cPs.
B. A liquid conditioning composition according to paragraph A, further comprising perfume encapsulates.
C. A liquid conditioning composition according to any of Paragraphs A-B, where the perfume encapsulates are present in the composition in an amount of between about 0.05% and about 10%.
D. A liquid conditioning composition according to any of Paragraphs A-C, wherein the perfume encapsulates are characterized by a volume-weighted medial particle size from about 1 to about 100 microns.
E. A liquid conditioning composition according to any of Paragraphs A-D, wherein the perfume encapsulates are coated with a deposition aid, a cationic polymer, a non-ionic polymer, an anionic polymer, or mixtures thereof.
F. A liquid conditioning composition according to any of Paragraphs A-E, wherein the composition comprises from about 3% to about 7%, or more preferably about 3% to about 6%, by weight of the composition, of alkyl ester quaternary ammonium softening active.
G. The liquid conditioning composition according to any of Paragraphs A-F, wherein the composition comprises from about 0.05% to about 4%, or more preferably from about 0.1% to about 3%, or more preferably about 0.5% to about 2%, by weight of the compositions, of free perfume oil.
H. The liquid conditioning composition according to any of Paragraphs A-G, wherein the composition comprises from 0.001% to about 0.02%, or more preferably from 0.0015% to about 0.015%, or more preferably from 0.002% to about 0.01%, by weight of the composition, of chitosan.
I. The liquid conditioning composition according to any of Paragraphs A-H, wherein the composition has a viscosity of about 90 to about 250 cPs, or more preferably about 150 to about 250 cPs.
J. The liquid conditioning composition according to according to any of Paragraphs A-I, wherein the liquid conditioning composition further comprises a treatment adjunct selected from the group consisting of: additional conditioning agents, dyes, pH control agents, solvents, rheology modifiers, structurants, cationic polymers, surfactants, perfume, perfume delivery systems, chelants, antioxidants, preservatives, or mixtures thereof; wherein the perfume delivery system, if present, preferably comprises core-shell encapsulates.
K. The liquid conditioning composition according to any of Paragraphs A-J, wherein the liquid conditioning composition comprises between about 0.05% and 2%, preferably less than 2%, preferably less than 1%, even more preferably less than 0.6% of a rheology modifier, a structurant, or a mixture thereof.
L. The liquid conditioning composition according to any of Paragraphs A-K, wherein the liquid conditioning composition comprises an antioxidant, preferably a phenolic antioxidant, more preferably a tocopherol or a derivative thereof.
M. A method of treating a surface, the method comprising the step of contacting a surface, preferably a fabric, more preferably a fabric comprising cotton fibers, with a liquid conditioning composition according to any of Paragraphs A-L, optionally in the presence of water.
N. Use of a liquid conditioning composition according to any of Paragraphs A-M to soften a fabric.
O. A liquid conditioning composition according to any of Paragraphs A-N including from about 3% to about 6%, by weight of the composition, of an alkyl ester quaternary ammonium softening active, from 0.002% to about 0.01%, by weight of the composition, of chitosan, and from 0.05 to about 2%, by weight of the composition, of free perfume oil, wherein the composition has a viscosity of about 150 to about 250 cPs.

### Test Methods

### Method to Assess Degree of Deacetylation

The following test method is used to determine the degree of deacetylation of chitosan.

The degree of deacetylation of chitosan test material is determined via Nuclear Magnetic Resonance (NMR) spectroscopy. Chitosan test material (10 mg) is dissolved in 1 mL of diluteacidic D20 (>99.9%, such as available from Aldrich). A Bruker NMR instrument model DRX 300 spectrometer (300 MHz) (Bruker Corp., Billerica, Massachusetts, USA) or similar instrument is used to measure the 1H NMR at 298 Kelvin. The 1H chemical shifts are expressed from the signal of 3-(trimethylsilyl) propionic-2,2,3,3-d4 acid sodium salt (>98%, such as available from Aldrich) which is used as an external reference. The degree of deacetylation is calculated from the measured chemical shifts according to standard and widely used approach described in the publication: Hirai et al., Polymer Bulletin 26 (1991), 87-94.

### Method for Determining Dynamic Yield Stress

Dynamic yield stress is measured using a controlled stress rheometer (such as an HAAKE MARS from Thermo Scientific, or equivalent), using a 60 mm parallel plate and a gap size of 500 microns at 20° C. The dynamic yield stress is obtained by measuring quasi steady state shear stress as a function of shear rate starting from 10 s-1 to 10-4 s-1, taking 25 points logarithmically distributed over the shear rate range. Quasi-steady state is defined as the shear stress value once variation of shear stress over time is less than 3%, after at least 30 seconds and a maximum of 60 seconds at a given shear rate. Variation of shear stress over time is continuously evaluated by comparison of the average shear stress measured over periods of 3 seconds. If after 60 seconds measurement at a certain shear rate, the shear stress value varies more than 3%, the final shear stress measurement is defined as the quasi state value for calculation purposes. Shear stress data is then fitted using least squares method in log space as a function of shear rate following a Herschel-Bulkley model:

$$T = To + {ky}^{″} n$$

wherein T is the measured equilibrium quasi steady state shear stress at each applied shear rate y, To is the fitted dynamic yield stress. k and n are fitting parameters.

### Method to Assess the Phase Stability of LFE Products

To assess the phase stability of a fabric enhancer product, typically the product is stored in one or several transparent 180 ml glass jars, sealed with a lid. These glass jars are then put in a constant temperature room (e.g., 25° C. or 35° C.). The phase stability of the fabric enhancer products is then assessed by a person skilled in the art after certain periods of time, such as every week for a period of 1 month, followed by monthly checks. To be able to see a visual indication of the smallest of phase instabilities, the observer needs to look at the entire sample very carefully. The bottom of the glass jar needs to be looked at carefully as well. A bright light or lamp is preferably used to illuminate the sample.

When assessing the phase stability of many samples, a phase split grading scale may be used, which allows to translate visual gradings into numbers. Table 1 below shows the phase stability grading scale utilized for the fabric enhancers as described and tested herein. A picture of each failure level is also provided.

TABLE 1

| Failure Level | |
|---|---|
| Assessment Score | Failure Description |
| 0 | No failure |
| 1 | very small cracks in bottom (difficult to see) |
| 2 | Cracks in bottom (easy to see) |
| 3 | Big Cracks (almost Phase Split) |
| 4 | Phase Split <5% |
| 5 | Phase Split >5% |

FIG. 1 depicts an example of a Failure Level 1, which is the appearance of very small cracks in the bottom of the clear glass jar. An arrow has been added to point to the appearance of a crack in the sample, i.e., a visual indication of a very slight phase separation. These very small cracks can sometimes be difficult to discern, very often only visible with the use of bright light to illuminate the sample. Failure Level 1 cracks are often only visible at the bottom of the clear glass jar.

FIG. 2 depicts an example of a Failure Level 2, which is the appearance of cracks in the bottom of the clear glass jar. The Failure Level 2 is easier to discern than Failure Level 1, but it may still be helpful to use a bright light to illuminate the sample. Failure Level 2 often has multiple cracks visible, and the cracks are more pronounced than the crack(s) that would only qualify for aa Failure Level 1. Failure Level 2 cracks are often only visible at the bottom of the clear glass jar.

FIG. 3 depicts an example of a Failure Level 3, which is the appearance of one or more big cracks in the bottom of the clear glass jar. Failure Level 3 cracks are often only visible at the bottom of the clear glass jar but sometimes also be seen from the side of the jar.

FIG. 4 depicts an example of a Failure Level 4, which is the appearance of a phase split of less than 5% of the sample material in the clear glass jar. Failure Level 4 cracks are often visible at the bottom of the clear glass jar, as well as the side of the jar. FIG. 4 shows the phase split from the side of the jar, located in the bottom portion of the jar.

FIG. 5 depicts an example of a Failure Level 5, which is the appearance of a phase split of more than 5% of the sample material in the clear glass jar. Failure Level 5 cracks are often visible at the bottom of the clear glass jars (two samples shown), as well as the side of the jars. FIG. 5 shows the phase split from the side of the jars, located in the bottom portion of the jars.

### Method to Determine Headspace Concentration Above Liquid Fabric Enhancers

The liquid fabric enhancers are analyzed by a fast headspace GC/MS (gas chromatography mass spectrometry) approach. 1 g aliquot of the liquid fabric enhancer were transferred to 25 ml headspace vials and capped. The headspace vials were equilibrated for 10 minutes@ 30° C. The headspace above the liquid solutions was sampled via SPME (50/30 μm DVB/Carboxen/PDMS) approach for 5 minutes. The SPME fibre was subsequently on-line thermally desorbed into the GC. The analytes were analyzed by fast GC/MS in full scan mode. Ion extraction of the specific masses of the PRMs was used to calculate the total HS response and perfume headspace composition above the tested liquid fabric enhancer.

### Method to Determine Headspace Concentration Above Treated Wet and Dry Fabrics

The cotton tracers are analyzed by a fast headspace GC/MS (gas chromatography mass spectrometry) approach. 4×4 cm aliquots of the terry towel cotton tracers were transferred to 25 ml headspace vials. The fabric samples were equilibrated for 10 minutes@ 65° C. The headspace above the fabrics was sampled via SPME (50/30 μm DVB/Carboxen/PDMS) approach for 5 minutes. The SPME fiber was subsequently on-line thermally desorbed into the GC. The analytes were analyzed by fast GC/MS in full scan mode. Ion extraction of the specific masses of the PRMs was used to calculate the total HS response and perfume headspace composition above the tested legs.

### Method to Determine the Encapsulated Oil Content in Liquid Fabric Enhancers

A sample aliquot is diluted into water. The perfume microcapsules are isolated via filtration (5-micron filter). After spiking with internal standard and addition of ethanol the perfume is released by heating to 60° C. for ½ hour. The encapsulated perfume content is analyzed by GC/MS via an internal standard calibration method.

### Determination of a Polymer's Molecular Weight and Related Parameters

The following method describing gel permeation chromatograph with multi-angle light scatter and refractive index detection (GPC-MALS/RI) is used to find molecular weight distribution measurements and related values of the polymers described herein.

Gel Permeation Chromatography (GPC) with Multi-Angle Light Scattering (MALS) and Refractive Index (RI) Detection (GPC-MALS/RI) permits the measurement of absolute molecular weight of a polymer without the need for column calibration methods or standards. The GPC system allows molecules to be separated as a function of their molecular size. MALS and RI allow information to be obtained on the number average (Mn) and weight average (Mw) molecular weight.

The Mw distribution of water-soluble polymers like chitosan is typically measured by using a Liquid Chromatography system (e.g., Agilent 1260 Infinity pump system with OpenLab Chemstation software, Agilent Technology, Santa Clara, CA, USA) and a column set (e.g., 2 Tosoh TSKgel G6000WP 7.8×300 mm 13 μm pore size, guard column A0022 6 mm×40 mm PW xl-cp, King of Prussia, PA) which is operated at 40° C. The mobile phase is 0.1M sodium nitrate in water containing 0.02% sodium azide and 0.2% acetic acid. The mobile phase solvent is pumped at a flow rate of 1 mL/min, isocratically. A multiangle light scattering (18-Angle MALS) detector DAWN® and a differential refractive index (RI) detector (Wyatt Technology of Santa Barbara, Calif., USA) controlled by Wyatt Astra® software v8.0 are used.

A sample is typically prepared by dissolving chitosan materials in the mobile phase at ˜1 mg per ml and by mixing the solution for overnight hydration at room temperature. The sample is filtered through a 0.8 μm Versapor membrane filter (PALL, Life Sciences, NY, USA) into the LC autosampler vial using a 3-ml syringe before the GPC analysis.

A dn/dc value (differential change of refractive index with concentration, 0.15) is used for the number average molecular weight (Mn), weight average molecular weight (Mw), Z-average molecular weight (Mz), molecular weight of the peak maxima (Mp), and polydispersity (Mw/Mn) determination by the Astra detector software.

### Examples

The examples provided below are intended to be illustrative in nature and are not intended to be limiting.

Table 2 shows exemplary liquid conditioning compositions according to the present disclosure. Specifically, the following compositions are intended as liquid fabric enhancer products.

TABLE 2

| | % Active (w/w) | | |
|---|---|---|---|
| | Composi- | Composi- | Composi- |
| Ingredient | tion 1 | tion 2 | tion 3 |
| Alkyl quaternary ammonium | 3% | 6% | 8% |
| ester softening active (Ester | | | |
| Quat) | | | |
| Perfume Encapsulates* | 0.25% | 0.1% | 0% |
| Perfume oil | 1% | 0.5% | 1% |
| Formic Acid | 0.045% | 0.045% | 0% |
| Hydrochloric acid | 0.01% | 0.008% | 0.025% |
| Chelant | 0.0071% | 0% | 0% |
| Deposition polymer | 0.09% | 0.09% | 0% |
| Structurant | 0.5% | 0.25% | 0.1% |
| Antifoam | 0.004% | 0.00% | 0.00% |
| Chitosan | 0.01% | 0.01% | 0.008% |
| Dyes | 0.016% | 0% | 0.016% |
| Water | Balance | Balance | Balance |
| Viscosity | 205 cP | 195 cP | 200 cP |

*Core-shell perfume capsules. The “% Active” provided is the amount of fragrance delivered to the composition.

### Example 1. Neat Product Odor

Four liquid treatment compositions (fabric enhancer products) were prepared by a skilled person according to the formulations provided in Table 3 below.

TABLE 3

| | % Active (w/w) | | | |
|---|---|---|---|---|
| | Composi- | | Composi- | |
| | tion 1 | Composi- | tion 3 | Composi- |
| Ingredient | Comparative | tion 2 | Comparative | tion 4 |
| Alkyl quaternary | 6% | 6% | 6% | 6% |
| ammonium ester | | | | |
| softening active | | | | |
| Perfume | 0% | 0% | 0.0831% | 0.0831% |
| Encapsulates* | | | | |
| Perfume oil | 1.0% | 1.0% | 1.0% | 1.0% |
| Formic Acid | 0.045% | 0.045% | 0.045% | 0.045% |
| Hydrochloric acid | 0.0234% | 0.0234% | 0.0234% | 0.0234% |
| Structurant | 0.1% | 0.1% | 0.1% | 0.1% |
| Antifoam | 0.004% | 0.004% | 0.004% | 0.004% |
| Chitosan | 0% | 0.01% | 0% | 0.01% |
| Dyes | 0.0161% | 0.0161% | 0.0161% | 0.0161% |
| Water | Balance | Balance | Balance | Balance |
| Viscosity | 241 cPs | 98 cPs | 113 cPs | 106 cPs |

The headspace intensity above the neat product was then assessed according to Method to Determine Headspace Concentration Above Liquid Fabric Enhancers, as detailed herein. Surprisingly, it was found that the headspace intensity above the compositions containing 0.01% chitosan (Composition 2 and Composition 4) was significantly higher than above the reference products without chitosan (Composition 1 and Composition 3). The results are graphed in FIG. 6, which shows Neat Product Odor Headspace for each of the four examples detailed above. Indeed, Composition 2 and Composition 4 have a significantly higher headspace (450 and 435 nmol/L) than Compositions 1 and 3 (397 and 410 nmol/L) respectively.

### Example 2. Fabric Enhancer Phase Stability as a Function of Chitosan Level

First, a Fabric Enhancer product was prepared according to the composition in Table 4 below:

TABLE 4

| | Composition 1 |
|---|---|
| Ingredient | % Active (w/w) |
| Alkyl quaternary ammonium | 6% |
| ester softening active (Ester | |
| Quat) | |
| Perfume oil | 0.4632% |
| Formic Acid | 0.045% |
| Hydrochloric acid | 0.0075% |
| Structurant | 0.23% |
| Antifoam | 0.004% |
| Polymer | 0.09% |
| Dyes | 0.0161% |
| Water | Balance |

In a second step, this product was split across eleven 180 ml glass jars. To each of these jars containing the product, a different level of chitosan was added while mixing for 2 minutes with an IKA overhead mixer, without incorporating air. The chitosan that was utilized was acid treated (as described herein), with a molecular weight of 200-250 kDa and a DDA (degree of deacetylation) of between 80% and 85%. The different levels of chitosan and measured viscosities of the compositions are detailed below in Table 5.

TABLE 5

| | | Viscosity after mixing |
|---|---|---|
| Composition | % Chitosan | (cPs) |
| A | 0.0685% | 189 |
| B | 0.0608% | 190 |
| C | 0.0551% | 193 |
| D | 0.0477% | 193 |
| E | 0.0409% | 193 |
| F | 0.0343% | 193 |
| G | 0.0267% | 193 |
| H | 0.0199% | 193 |
| I | 0.0141% | 193 |
| J | 0.0066% | 193 |
| K | 0.0042% | 193 |

These products were then stored for 4 weeks at 35° C.
In a third step, the phase stability of each composition was assessed after 4 weeks storage at 35° C., according to the Method to Assess the Phase Stability of LFE Products detailed herein. The phase stability failure level assessment scores be found in Table 6 below.

TABLE 6

| | Phase stability grading |
|---|---|
| Composition | after 4 weeks at 35 C. |
| A | 3 |
| B | 3 |
| C | 3 |
| D | 3 |
| E | 2 |
| F | 2 |
| G | 2 |
| H | 1 |
| I | 1 |
| J | 1 |
| K | 0 |

From Table 6 above it can be found that up to a level of about 0.02% chitosan in the fabric enhancer composition, the phase stability assessment is not worse than Failure Level 1. Typically, consumers expect a phase stable fabric enhancer product when purchasing a bottle in a store. It is expected that a Failure Level assessment of higher than 2 will disappoint consumers, as the phase split becomes visible to the untrained eye. Failure Level assessments of 1 or 0 are generally acceptable to consumers.

### Example 3. Triethanolamine Based Ester Quat/Phase Stability of Commercial Liquid Fabric Enhancer as a Function of Chitosan Level

In each of two glass jars, 180 ml of a commercially available liquid fabric softener Robijn “Puur en Zacht” (Unilever) was poured. This fabric softener comprises a triethanolamine based ester quat. To each of these jars with the liquid fabric softener product, a different level of chitosan was added and mixed for 2 minutes with an IKA overhead mixer, without incorporating air. The different levels of chitosan and measured viscosities of the compositions are detailed below in Table 7.

TABLE 7

| | | Viscosity after mixing |
|---|---|---|
| Composition | % chitosan | (cPs) |
| A | 0.0716% | 85 |
| B | 0.0034% | 39 |

These products were then stored for 4 weeks at 35° C.
After 4 weeks of storage at 35° C., the phase stability of each composition was assessed according to the Method to Assess the Phase Stability of LFE Products detailed herein. The phase stability failure level assessment scores be found in Table 8 below.

TABLE 8

| | Phase stability grading |
|---|---|
| Composition | after 4 weeks at 35 C. |
| A | 4 |
| B | 0 |

A picture of the Failure Level 4 phase split observed in Composition A after 4 weeks at 35° C. can be found in FIG. 7. There is an arrow pointing to the portion of the jar that identifies the visual phase split.

From Tables 7 and 8 above it can be noted that a high level of chitosan added to Robijn “Puur en Zacht” leads to a Failure Level 4 phase split, whereas the Puur en Zacht product with a low level of chitosan shows no phase instability at all.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid conditioning composition comprising:
from about 2% to about 8%, by weight of the composition, of an alkyl ester quaternary ammonium softening active,
from 0.0001% to about 0.025%, by weight of the composition, of chitosan, and
from 0.01 to about 5%, by weight of the composition, of free perfume oil,
wherein the composition has a viscosity of about 80 to about 300 cPs.

2. The liquid conditioning composition of claim 1, further comprising perfume encapsulates.

3. The liquid conditioning composition of claim 2, where the perfume encapsulates are present in the composition in an amount of between about 0.05% and about 5%, by weight of the composition.

4. The liquid conditioning composition of claim 3, wherein the perfume encapsulates are characterized by a volume-weighted medial particle size from about 1 to about 100 microns.

5. The liquid conditioning composition of claim 4, wherein the perfume encapsulates are coated with a deposition aid, a cationic polymer, a non-ionic polymer, an anionic polymer, or mixtures thereof.

6. The liquid conditioning composition of claim 1, wherein the composition comprises from about 3% to about 7%, or more preferably about 3% to about 6%, by weight of the composition, of alkyl ester quaternary ammonium softening active.

7. The liquid conditioning composition of claim 1, wherein the composition comprises from about 0.05% to about 4% of free perfume oil.

8. The liquid conditioning composition of claim 1, wherein the composition comprises from 0.001% to about 0.02%, by weight of the composition, of chitosan.

9. The liquid conditioning composition of claim 1, wherein the composition has a viscosity of about 90 to about 250 cPs.

10. The liquid conditioning composition according to claim 1, wherein the liquid conditioning composition further comprises a treatment adjunct selected from the group consisting of: additional conditioning agents, dyes, pH control agents, solvents, rheology modifiers, structurants, cationic polymers, surfactants, perfume, perfume delivery systems, chelants, antioxidants, preservatives, or mixtures thereof; wherein the perfume delivery system, if present, preferably comprises core-shell encapsulates.

11. The liquid conditioning composition according to claim 1, wherein the liquid conditioning composition comprises between about 0.05% and 2% of a rheology modifier, a structurant, or a mixture thereof.

12. The liquid conditioning composition according to claim 1, wherein the liquid conditioning composition comprises an antioxidant.

13. A method of treating a surface, the method comprising the step of contacting a surface, preferably a fabric, more preferably a fabric comprising cotton fibers, with a liquid conditioning composition according to claim 1, optionally in the presence of water.

14. Use of a liquid conditioning composition according to any claim 1 to soften a fabric.

15. A liquid conditioning composition comprising:
from about 3% to about 6%, by weight of the composition, of an alkyl ester quaternary ammonium softening active,
from 0.002% to about 0.01%, by weight of the composition, of chitosan, and
from 0.05 to about 2%, by weight of the composition, of free perfume oil,
wherein the composition has a viscosity of about 150 to about 250 cPs.

16. The liquid conditioning composition of claim 15, further comprising perfume encapsulates.

17. The liquid conditioning composition of claim 16, where the perfume encapsulates are present in the composition in an amount of between about 0.05% and about 5%, by weight of the composition.

18. The liquid conditioning composition of claim 17, wherein the perfume encapsulates are characterized by a volume-weighted medial particle size from about 1 to about 100 microns.

19. The liquid conditioning composition of claim 18, wherein the perfume encapsulates are coated with a deposition aid, a cationic polymer, a non-ionic polymer, an anionic polymer, or mixtures thereof.
